(19) United States
(12) Patent Application Publication
(10) Pub. No.: US 2025/0289527 A1
(43) Pub. Date: Sep. 18, 2025

(54) BICYCLE OR E-BIKE INTERFACE AND BICYCLE OR E-BIKE

(71) Applicant: PORSCHE EBIKE PERFORMANCE GMBH, Ottobrunn (DE)

(72) Inventor: Johannes BIECHELE, Riedering (DE)

(21) Appl. No.: 18/859,006

(22) PCT Filed: Mar. 30, 2023
(86) PCT No.: PCT/EP2023/058298

§ 371 Date: Oct. 22, 2024

(30) Foreign Application Priority Data
Apr. 22, 2022 (DE) 10 2022 109 790.0

(51) Int. Cl. B62J 50/22; B62J 43/30; B62J 45/20; B62M 6/40

(52) U.S. Cl. CPC B62J 50/22; B62J 43/30; B62J 45/20; B62M 6/40

(57) ABSTRACT

A bicycle or an e-bike interface for providing a connection between a bicycle or an e-bike and a data processing device, e.g., a mobile device, wherein the bicycle or e-bike interface has a plug, a plug socket, a holder, and an attachment component, wherein the plug socket is displaceably attached to the holder using the attachment component.

### CROSS-REFERENCE TO RELATED APPLICATIONS

This application is a 35 U.S.C. § 371 National Stage patent application of PCT/EP2023/058298, filed on 30 Mar. 2023, which claims the benefit of German patent application 10 2022 109 790.0, filed on 22 Apr. 2022, the disclosures of which are incorporated herein by reference in their entirety.

### TECHNICAL FIELD

The disclosure relates to a bicycle or e-bike interface for providing a connection between a bicycle or e-bike and a data processing device, e.g., a mobile device, such as a mobile phone. Furthermore, the disclosure relates to a bicycle or e-bike comprising such a bicycle or e-bike interface.

### BACKGROUND

In the context of this document, e-bikes include electric bicycles and also electric (kick) scooters, electric mopeds, and electric motorcycles. Bicycles or e-bikes are often single-track. They can also be multi-track, e.g., in the form of a three-wheeled cargo bike with or without an electric drive motor.

E-bikes have an electric drive motor. The electric drive motor can function as the sole drive, for example in an electric moped, an electric scooter, or an electric motorcycle. In particular, the electric drive motor can also be provided merely as an auxiliary drive, as in an electric bicycle. Electric bicycles, where the electric drive motor acts only as an auxiliary drive, for example only when the user pedals, are commonly referred to as pedelecs or S-pedelecs.

Bicycle or e-bike interfaces can be used, for example, to charge a data processing device, such as a mobile device, like a mobile phone or a navigation device, during longer tours.

Bicycles or e-bikes usually do not have a body, which is why bicycle or e-bike interfaces often need to be weather-resistant. Users also pay attention to the functionality, ease of use, and the visual appearance of bicycle or e-bike interfaces, as well as their optical and technical integration into the bicycle or e-bike.

One of the problems to be solved by the disclosure is therefore to provide a bicycle or e-bike interface that is improved, particularly in the aforementioned points. Furthermore, the disclosure aims to offer an improved bicycle or e-bike comprising such a bicycle or e-bike interface.

### SUMMARY

To solve the above-mentioned tasks, a bicycle or e-bike interface with the features recited in the claims and a bicycle or e-bike with the features recited in the claims are proposed.

It should be noted that the features listed individually in the claims can be combined with each other in any technically meaningful way and show further embodiments of the disclosure. The description further characterises and specifies the disclosure, in particular in connection with the figures. The features described in connection with the bicycle or e-bike interface can also be advantageous embodiments of the bicycle or e-bike and vice versa.

It should be noted that the features listed individually in the claims can be combined with each other in any technically meaningful way and show further embodiments of the disclosure. The description characterizes and specifies the disclosure in particular in connection with the figures additionally. Also, the features described in connection with the bicycle or e-bike interface can be advantageous embodiments of the bicycle or e-bike and vice versa.

It should also be noted that a conjunction “and/or” used herein between two features and linking them should always be interpreted such that in a first embodiment only the first feature may be present, in a second embodiment only the second feature may be present, and in a third embodiment both the first and the second feature may be present.

According to the disclosure, a bicycle or e-bike interface is proposed for providing a connection between a bicycle or e-bike and a data processing device, e.g., a mobile device. The bicycle or e-bike interface has a plug, a plug socket, a holder, and attachment means. The plug socket is displaceably attached to the holder by means of the attachment means.

Due to the displaceable attachment of the plug socket to the holder, protection, e.g., weather protection, of the plug and/or an especially visually appealing appearance of the bicycle or e-bike interface can be achieved, particularly when the plug is not connected to a mating connector or the bicycle or e-bike interface is not in use, while maintaining comfortable usability of the bicycle or e-bike interface, especially with a comfortably manufacturable plug connection.

The plug is preferably a connector and more preferably a charging and/or data connector. Preferably, the plug serves to establish a plug connection with a mating connector, which in particular belongs to the data processing device and can be designed as a mating connector.

The data processing device can be a mobile device, especially with a supply accumulator. The mobile device can be, for example, a mobile phone or a navigation device.

The data processing device can be a diagnostic device. The diagnostic device can preferably display the condition of the bicycle or e-bike, e.g., the mileage of the bicycle or e-bike and/or the condition of a drive accumulator of the e-bike, e.g., its capacity, relative to the capacity in new condition.

Preferably, the bicycle or e-bike interface is designed such that it can be used—and preferably by means of the plug—to provide charging current for a data processing device, especially designed as a mobile phone or navigation device.

The bicycle or e-bike interface is preferably designed such that it can be used—and preferably by means of the plug—to transfer data between the bicycle or e-bike and the data processing device, especially designed as a diagnostic device.

In a particularly advantageous embodiment, the bicycle or e-bike interface is designed such that it can be used—and preferably by means of the plug—to provide both charging current for a data processing device, especially designed as a mobile phone or navigation device, and, simultaneously or sequentially, to transfer data between the bicycle or e-bike and the data processing device, especially designed as a diagnostic device.

The connection between the bicycle or e-bike and the data processing device, for the establishment of which the bicycle or e-bike interface is used, is preferably electrical or electronic. Preferably, a galvanic connection between the bicycle or e-bike and the data processing device can be established by means of the plug. The connection can also include an operative connection, for example via radio, without physical contact or without a galvanic connection.

Preferably, the plug is attached to the plug socket, preferably immovably relative to it, for example, by form-fit and/or material-fit. Preferably, the plug is—preferably firmly—installed or integrated into the plug socket. The plug can also preferably be referred to as an installation plug or as a socket.

Preferably, the holder is designed to be fixed to the bicycle or the e-bike. By means of the holder, a mechanical connection of the plug socket to the bicycle or e-bike can preferably be established. The holder can also be formed by the bicycle or e-bike frame or bicycle or e-bike handlebar stem, e.g., in the form of a recess in the frame or handlebar stem of the bicycle or e-bike.

Preferably, the bicycle or e-bike interface is designed such that the establishment of a plug connection by connecting a mating connector to the plug is possible with one hand.

By having the plug attached to the plug socket and the plug socket, as particularly preferred, attached to the holder, the establishment of a plug connection by connecting the plug to a mating connector is more comfortable compared to the conceivable alternative where the plug is arranged at a loose cable end. Additionally, this can create a prerequisite for the establishment of a plug connection by connecting a mating connector to the plug to be possible with one hand.

The attachment means, by which the plug socket is displaceably attached to the holder, can be designed as bearings and/or guide elements.

According to an advantageous embodiment, the attachment means comprise socket attachment means arranged on the plug socket. According to an advantageous embodiment, the attachment means also comprise holder attachment means arranged on the holder. The socket attachment means and the holder attachment means are preferably designed to correspond to one another.

The attachment means can be specialized for their attachment function. The attachment means can exclusively have an attachment function. Alternatively, the attachment function can be given in addition to another function of the attachment means. One of the attachment means can, for example, comprise or be formed by a section of the bicycle frame, which interacts with another attachment means.

In a preferred embodiment, the plug socket is pivotably attached to the holder by means of the attachment means around a pivot axis. The displaceable attachment can thus specify or allow a rotational movement of the plug socket relative to the holder.

If the pivot axis is virtual, i.e., the pivot movement is not specified by a bearing bolt defining the pivot axis, then a particularly simple manufacturing and/or assembly of the bicycle or e-bike interface can result.

Even if the pivot axis is displaceable, this can be beneficial to the manufacturing and/or assembly of the bicycle or e-bike interface.

The displaceable attachment can alternatively or additionally allow a translational movement of the plug socket relative to the holder.

A particularly good protection of the plug socket or the plug, e.g., against weather and/or a particularly visually appealing bicycle or e-bike interface can be achieved if the attachment means are designed such that they allow a displacement of the plug socket relative to the holder between a first, preferably pivoted-in, position of the plug socket, and a second, preferably pivoted-out, position of the plug socket.

Advantageously, the plug socket can be moved from the first position to the second position by moving the plug socket or a region of the plug socket away from the holder.

In a preferred embodiment, the plug socket is floatingly mounted in the holder by means of the attachment means. This means, in particular, that the plug socket can perform a variety of arbitrary movements relative to the holder—preferably within a movement limitation effected by stops.

Preferably, the plug socket has a handle. Preferably, the handle facilitates a user to displace the plug socket from the first position to the second position.

The plug socket can be exposed to the weather, and the plug can also be exposed to the weather at least in the second position of the plug socket.

In a particularly advantageous embodiment, the plug is protected from dirt and weather, e.g., rain, in the first position of the plug socket. A sealing device can be provided, in particular between the plug socket and the holder, to protect the plug from dirt and weather in the first position of the plug socket.

Preferably, the plug has a plug face. Preferably, the plug, in particular its plug face, is at least partially recessed in the holder in the first position of the plug socket, preferably such that the plug is inaccessible for establishing and/or disconnecting a plug connection and is further preferably protected from the weather.

Preferably, the plug, in particular its plug face, is at least partially arranged outside the holder in the second position of the plug socket, preferably such that the plug is accessible for establishing and/or disconnecting a plug connection.

Preferably, the bicycle or e-bike interface comprises return means. Preferably, the return means can effect an automatic return displacement of the plug socket to the first position after the plug socket has been displaced to its second position. This can achieve a further increase in comfort. In an embodiment, the return means effect a pulling force between the plug socket and the holder. This can easily effect an automatic return displacement of the plug socket from the second position to the first position.

The return means can, for example, comprise a tension or leg spring. In particular, if the return means, preferably by means of the pulling force, also prevent the plug socket from moving away from the holder or prevent the plug socket from being displaced from the first position to the second position independently, i.e., effect a fixation of the plug socket in the first position, they can also be referred to as retaining means.

If the pulling force is greater in the first position of the plug socket than in the second position, then the ease of use can be further increased. For example, a user only has to exert a lower counterforce during the establishment of a plug connection in the second position, with a sufficiently large pulling force in the first position of the plug socket for reliable fixation in the first position.

In a preferred embodiment, the return means comprise a socket return means arranged on the plug socket and a holder return means interacting with it, arranged on the holder.

A compact bicycle or e-bike interface can be achieved if a displacement from the second position to the first position is only possible when no plug connection is established.

Preferably, a mating connector forming a plug connection with the plug can be clamped by means of the return means. This can effect or support a strain relief of the plug connection.

Alternatively, the plug socket can be in a lock-in position in the second position, in which the pulling force of the return means is absorbed by a locking device.

Preferably, the return means act without contact. To effect the pulling force by the return means, it is therefore preferably not necessary for the return means to touch each other or to be connected to each other by touching. This can simplify the assembly of the bicycle or e-bike interface.

Particularly suitable return means can be achieved if the return means comprise a magnet and a magnetic counterpart, and the pulling force is preferably provided by the magnetic attraction force. Since the magnetic attraction force increases with decreasing distance between the magnet and the magnetic counterpart, this can easily achieve that the pulling force is greater in the first position of the plug socket than in the second position.

Simple assembly or maintenance of the bicycle or e-bike interface can be achieved if the plug socket can be connected to the holder without tools, preferably latched, and/or can be disconnected from it, preferably clicked out. The term “clicked out” particularly means non-destructive disconnection after overcoming an elastic force and/or after releasing a form fit formed by spring-loaded elements.

Preferably, both the attachment means and the return means allow the plug socket to be connected to and/or disconnected from the holder without tools.

A particularly robust displaceable attachment of the plug socket to the holder can be achieved if the attachment means comprise at least one, preferably curved, guide slot and a sliding block engaging in the guide slot. The at least one guide slot can be arranged on the plug socket. The at least one sliding block can be arranged on the holder. A reversed arrangement is possible. The guide slot can effect the virtuality of the pivot axis. The curvature of the guide slot can define or contribute to the radius of the rotational movement of the plug socket relative to the holder.

Even if the attachment means comprise at least one protrusion, which provides a stop with at least one counter protrusion, a particularly robust displaceable attachment of the plug socket to the holder can be achieved. The at least one protrusion is preferably arranged on the plug socket. The at least one counter protrusion is preferably arranged on the holder. A reversed arrangement is possible.

The attachment means can comprise at least one protrusion to form a stop, which can limit the movement of the plug socket away from the holder and define or contribute to the second position of the plug socket. If the protrusion is designed as a latching lug, then a prerequisite is created for the plug socket to be particularly suitably connected to and/or disconnected from the holder without tools. The latching lug is preferably, as is usual for latching lugs, spring-mounted. The plug socket can be clicked out by displacing the latching lug against the force of this spring.

In a particularly advantageous embodiment, the attachment means comprise two opposite guide slots and sliding blocks.

If the at least one sliding block, particularly similar to a latching lug, is spring-mounted, preferably on the plug socket or the holder, then again a prerequisite is created for the plug socket to be particularly suitably connected to and/or disconnected from the holder without tools. Simple manufacturing and assembly can result if this spring is formed integrally with the plug socket or the holder, for example as a leaf spring. The plug socket can be clicked out by displacing the sliding block against the force of this spring.

Preferably, the holder comprises fixing means for attaching the holder to the bicycle or e-bike.

Further preferably, the fixing means comprise at least one retaining clip for engaging behind a region of the bicycle or e-bike, for example, an inner wall of the frame.

The fixing means can also comprise a screw, wherein the screw can interact with a nut, which can be designed as a fork nut.

The screw and the retaining clip can each be arranged in an end region of the holder. These end regions can be opposite each other.

The fork nut can comprise a fork head. The fork head can comprise a female thread and fork prongs for support on the bicycle or e-bike, for example on an inner wall of the frame. The nut can be arranged on the holder in a captive manner by means of a catch strap and a holding claw. The catch strap can be arranged fixedly at one end to the nut and can be clicked or latched into the holding claw at the other end.

In an important embodiment, the plug comprises a USB plug or is formed thereby.

The USB plug can be, for example, a type A or micro USB plug. Preferably, it is a type C USB plug.

Preferably, the bicycle or e-bike interface is multifunctional.

In a preferred embodiment, the bicycle or e-bike interface has a display device, for example, at least one LED and/or a matrix display, such as an LCD display. Preferably, the bicycle or e-bike interface can thus additionally take over a display function in addition to the function of charging a mobile device by means of the bicycle or the e-bike and/or transferring data between the bicycle or e-bike and the data processing device. Advantageously, the display device is designed to display the charge state of an accumulator and/or a selected support level of a drive motor. This accumulator can be, for example, the drive accumulator of the e-bike and/or the supply accumulator of a mobile device connected via the plug. The display device can be designed to display the condition of the bicycle or e-bike, e.g., the mileage of the bicycle or e-bike and/or the condition of a drive accumulator of the e-bike, e.g., its capacity, relative to the capacity in new condition. Preferably, the display device is designed separately from the plug and preferably does not interact with it.

The bicycle or e-bike interface can have a radio module for data transmission via Bluetooth.

The bicycle or e-bike interface can have control elements. In one embodiment, switching between different views of the display device can be effected by means of the control elements. In another embodiment, switching between different support levels of the drive motor can be effected by means of the control elements.

The bicycle or e-bike interface can allow wired communication between the bicycle or e-bike and the periphery, such as a user's mobile device, via the plug. This communication can also be possible wirelessly via the radio module.

Furthermore, a preferably single-track bicycle or e-bike is proposed, comprising a bicycle or e-bike interface as described above.

The bicycle or e-bike is preferably single-track. The bicycle or e-bike can also be a trike, i.e., three-track. The bicycle can be exclusively or at least also muscle-powered. The e-bike can be exclusively or at least also powered by the electric drive motor. The e-bike can be muscle-powered and powered by the electric drive motor. The e-bike can be designed such that the electric drive motor only acts or only fully acts when the user pedals simultaneously. In particular, in this embodiment, the e-bike can also be referred to as a pedelec or S-pedelec.

Advantageously, the bicycle or e-bike has a frame, preferably with a top tube and/or a down tube. Preferably, the holder is fixed to the bicycle or e-bike frame, preferably to the top tube and/or a down tube. The holder can also be formed by the bicycle or e-bike frame, for example, the top tube or down tube.

The bicycle or e-bike preferably has a handlebar stem. In a conceivable embodiment, the holder is arranged on the handlebar stem or formed by it.

The bicycle or e-bike is preferably designed such that, with the help of the bicycle or e-bike interface, both charging current for a data processing device, especially designed as a mobile phone or navigation device, can be provided, and data between the bicycle or e-bike and a data processing device, especially designed as a diagnostic device, can be transferred simultaneously or sequentially. For this purpose, the bicycle or e-bike can have charging electronics and/or data provision electronics.

A particularly good protection of the plug or the plug socket and/or a particularly visually appealing bicycle or e-bike interface can be achieved if the plug is recessed in the holder or in the bicycle or e-bike frame or handlebar stem in the first position of the plug socket, particularly such that it is not visible from the outside.

The accessibility of the plug for establishing and/or disconnecting a plug connection in the second, preferably pivoted-out position of the plug socket, can be particularly well achieved if the plug protrudes from the holder or from the bicycle or e-bike frame or handlebar stem in the second position of the plug socket.

Preferably, the plug socket attaches the plug to the bicycle or e-bike. Compared to a conceivable alternative where the plug is arranged at a loose cable end, this facilitates the establishment of a plug connection and can enable the one-handed establishment of the plug connection.

In a preferred embodiment, the bicycle or e-bike, in the alternative as an e-bike, has an electric drive motor and a drive accumulator. Preferably, the bicycle or e-bike interface, in the alternative as an e-bike interface, is connected to the electric drive motor and/or the drive accumulator by means of an electrical line.

In the alternative where the bicycle or e-bike is an e-bike, and the bicycle or e-bike interface is an e-bike interface, the advantages of the disclosure come particularly well to the fore, as on the one hand, the e-bike interface can use the drive accumulator of the e-bike as a power source for charging the data processing device, especially the mobile device, which allows a particularly uninterrupted charging process compared to the possible use of a dynamo. On the other hand, there is an increased need for data transmission, for example, about the condition and age of the drive accumulator or electric drive motor.

If the e-bike has an electrical line between the bicycle or e-bike interface and the electric drive motor and/or the drive accumulator, then a prerequisite for particularly suitable information exchange between this motor or this accumulator and the bicycle or e-bike interface or for the advantageous charging of the data processing device is created. The e-bike interface can then particularly well make this information or the charging current available, for example, via the plug. In one embodiment, the e-bike interface can then particularly well display this information via the display device.

Preferably, a connection between the bicycle or e-bike and the data processing device can be provided by means of the bicycle or e-bike interface. Preferably, the bicycle or e-bike interface is connected on the one hand to the drive accumulator and the electric drive motor by means of the electrical line and can be connected on the other hand to the data processing device by means of an additional electrical line.

Advantageously, the display device indicates operating states of elements of the bicycle or e-bike or of a data processing device connected to the bicycle or e-bike.

### BRIEF DESCRIPTION OF THE DRAWINGS

The present disclosure is explained in detail below using exemplary embodiments with reference to the accompanying figures. The figures show:

FIG. 1 a perspective view of an embodiment of a bicycle or e-bike interface,

FIG. 2 a part of a bicycle or e-bike comprising the bicycle or e-bike interface shown in FIG. 1,

FIG. 3 a perspective view of the plug socket of the bicycle or e-bike interface shown in FIG. 1,

FIG. 4 a view as in FIG. 3, but from a different angle,

FIG. 5 a perspective view of the holder of the bicycle or e-bike interface shown in FIG. 1,

FIG. 6 a view as in FIG. 5, but from a different angle,

FIG. 7 a side view of the bicycle or e-bike interface shown in FIG. 1, with the plug socket attached to the holder and in the first position,

FIG. 8 a view as in FIG. 7, but with the plug socket in the second position,

FIG. 9 a view as in FIG. 7, but with the plug socket not attached to the holder, and

FIG. 10 a view as in FIG. 8, with the bicycle or e-bike interface connected to a data processing device on one side and to the drive accumulator on the other side.

### DETAILED DESCRIPTION OF THE DRAWINGS

In the figures, unless otherwise indicated, the same reference signs denote the same components with the same function.

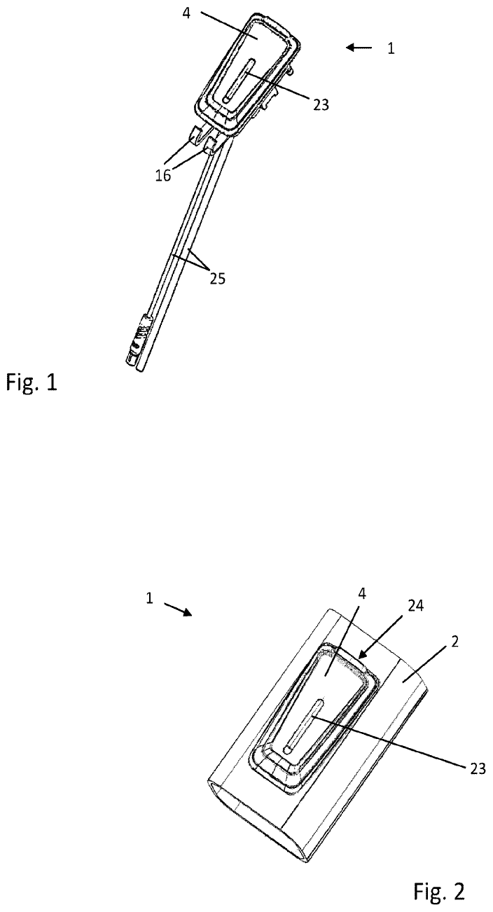

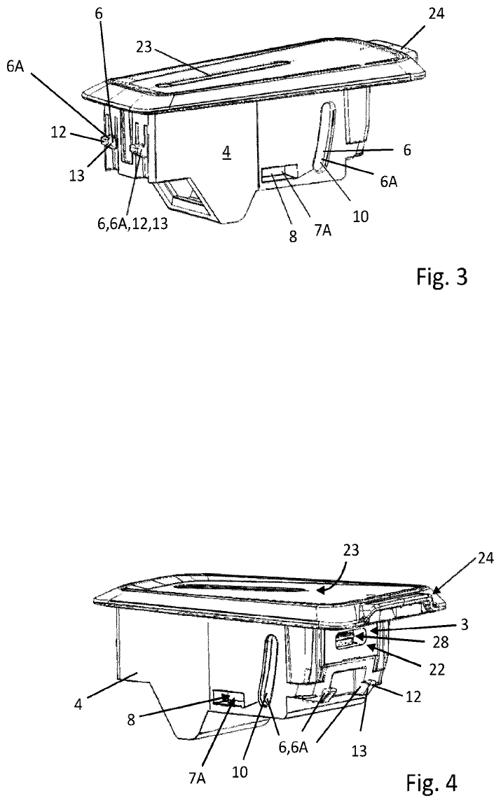

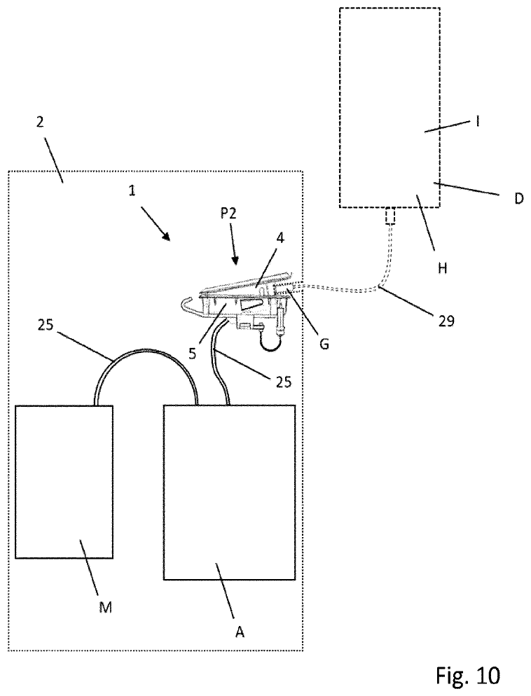

FIG. 1 shows an embodiment of a bicycle or e-bike interface 1 for providing a connection between a bicycle or e-bike 2 and a data processing device D, in the alternative as an e-bike interface. The data processing device D is a mobile device H, specifically a mobile phone I (see FIG. 10). The e-bike interface 1 comprises a plug 3, a plug socket 4, a holder 5, and attachment means 6. The plug socket 4 is displaceably attached to the holder 5 by means of the attachment means 6 (see FIGS. 3 to 6 and 8).

The e-bike interface 1 or the e-bike 2 is designed such that, by means of the plug 3, both charging current for a data processing device D, designed as a mobile device H, specifically a mobile phone I, can be provided sequentially, and data between the bicycle or e-bike 2 and the data processing device D, designed as a diagnostic device (not shown in the figures), can be transferred.

As best shown in FIG. 4, the plug 3 is attached to and integrated into the plug socket 4.

The attachment means 6 comprise socket attachment means 6A arranged on the plug socket 4 and holder attachment means 6B arranged on the holder 5, which are designed to correspond to one another.

The plug socket 4 is floatingly mounted in the holder 5 by means of the attachment means 6. The attachment means 6 are designed such that they allow a displacement of the plug socket 4 relative to the holder 5 between a first, pivoted-in, position P1 of the plug socket 4 and a second, pivoted-out, position P2 of the plug socket 4. The plug 3, more precisely its plug face 28, is recessed in the holder 5 in the first position P1 of the plug socket 4, such that the plug 3 is inaccessible for establishing and/or disconnecting a plug connection and protected from the weather. The plug face 28 is arranged outside the holder 5 in the second position P2 of the plug socket 4, such that the plug 3 is accessible for establishing and/or disconnecting a plug connection (FIGS. 4, 7, and 8).

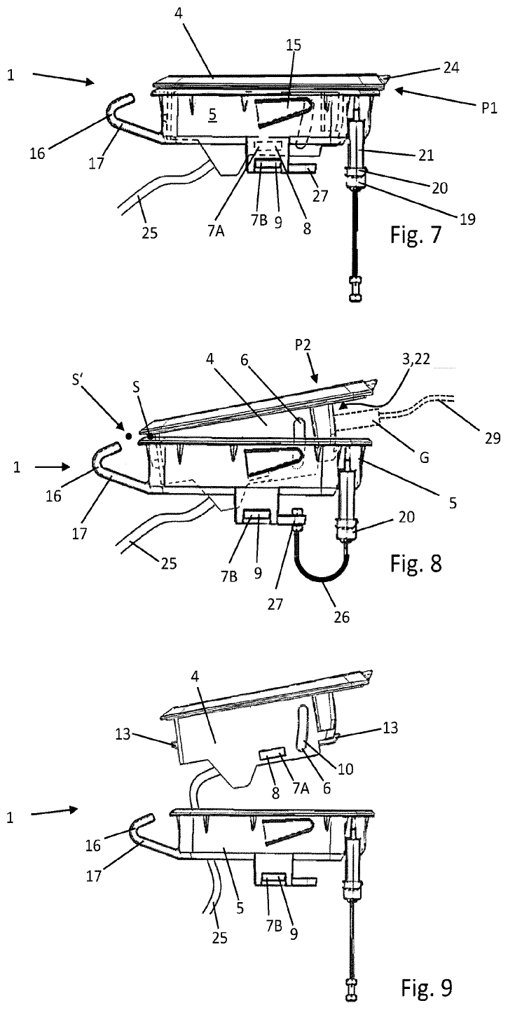

As can be seen, for example, from a combination of FIGS. 7 and 8, the plug socket 4 is pivotably attached to the holder 5 by means of the attachment means 6 around a pivot axis S, S′. The displaceable attachment thus allows a rotational movement of the plug socket 4 relative to the holder 5.

FIG. 8 shows two of many possible positions of the pivot axis S, S′. It is apparent that the pivot axis S, S′ is virtual and displaceable.

The handle 24 to facilitate the displacement of the plug socket 4 from the first position P1 to the second position P2 is shown, for example, in FIG. 4.

The e-bike interface comprises return means 7A, 7B, which act without contact and comprise a magnet 8 and a magnetic counterpart 9 (see, for example, FIG. 7)

Preferably, both the attachment means 6 and the return means 7A, 7B allow the plug socket 4 to be connected to and/or disconnected from the holder 5 without tools. Starting from the situation shown in FIG. 9, the plug socket 4 can be clicked into the holder 5.

In the shown embodiment, the attachment means 6 comprise four protrusions 12, each designed as a latching lug 13, arranged on the plug socket 4. These protrusions 12 each provide a stop with one of four counter protrusions 14 provided on the holder 5. The attachment means 6 also comprise two opposite curved guide slots 10 on the plug socket 4 and two sliding blocks 11, each engaging in the guide slot 10 and spring-mounted by means of a spring 15 on the holder 5 (FIGS. 3 to 6).

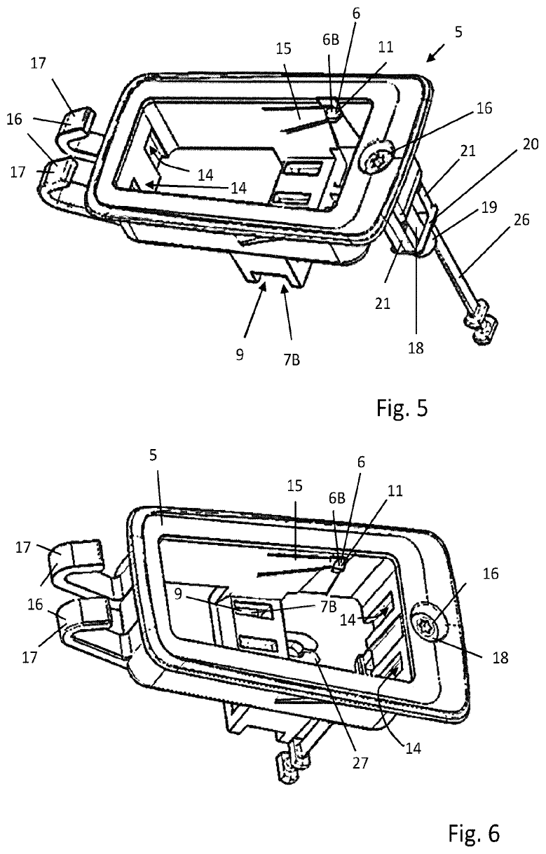

The holder 5 is designed to be fixed to the e-bike 2. FIG. 2 shows the fixed state. As can be seen, for example, in FIGS. 5 and 8, the holder 5 comprises fixing means 16 for attaching the holder 5 to the bicycle or e-bike 2. The fixing means 16 comprise two retaining clips 17 for engaging behind an inner wall of the frame of the bicycle or e-bike 2. The fixing means 16 also comprise a screw 18, which interacts with a fork nut 19. The screw 18 and the retaining clip are each arranged in an end region of the holder 5. These end regions are opposite each other (FIG. 5). The fork nut 19 comprises a fork head 20 with a female thread and fork prongs 21 for support on an inner wall of the frame of the e-bike. The fork nut 19 is arranged on the holder 5 in a captive manner by means of a catch strap 26 and a holding claw 27. For this purpose, the catch strap 26 can be clicked or latched into the holding claw 27, as shown in FIGS. 8 and 10.

The plug 3, not specifically shown in the figures, is formed by a USB plug 22.

In addition to the plug, the e-bike interface comprises a display device 23, namely several LEDs. The e-bike interface allows wired communication between the e-bike and the periphery, namely the mobile device H in the form of the user's mobile phone I and/or a diagnostic device, for example, a bicycle workshop.

Only a small frame section of the bicycle or e-bike 2 is shown in the figures (FIG. 2), in the alternative as an e-bike. The e-bike comprises a bicycle or e-bike interface 1 in the alternative as an e-bike interface, as described above. The holder 5 is fixed to the bicycle or e-bike frame.

The plug 3 is recessed in the holder 5 and in the e-bike frame in the first position P1, such that it is not visible from the outside (FIG. 2). In the second, pivoted-out position P2 of the plug socket 4, the plug 3 protrudes from the holder 5 and from the e-bike frame and can form a plug connection with a counter plug G (FIGS. 8 and 10).

FIG. 10 shows that the e-bike interface 1 provides a connection between the e-bike 2 and the data processing device D and that it is connected by means of an electrical line 25 on one side to the drive accumulator A and the electric drive motor M and on the other side to the data processing device D.

1. A bicycle or e-bike interface for providing a connection between a bicycle or e-bike and a data processing device (D), e.g., a mobile device, the bicycle or e-bike interface comprises: a plug, a plug socket, a holder, and attachment means, wherein the plug socket is displaceably attached to the holder by the attachment means.

2. The bicycle or e-bike interface according to claim 1, wherein the data processing device comprises a mobile device, e.g., a mobile phone, and the bicycle or e-bike interface is designed to be used to provide charging current for the mobile device.

3. The bicycle or e-bike interface according to claim 1, wherein the attachment means comprise socket attachment means arranged on the plug socket and holder attachment means arranged on the holder, which are designed to correspond to one another.

4. The bicycle or e-bike interface according to claim 1, wherein the plug socket is attached to the holder by the attachment means so as to be pivotable about a pivot axis.

5. The bicycle or e-bike interface according to claim 4, wherein the pivot axis is virtual and displaceable.

6. The bicycle or e-bike interface according to claim 1, wherein the attachment means are designed to enable a displacement of the plug socket relative to the holder between a first pivoted-in, position of the plug socket, in which the plug is at least partially recessed in the holder and a second, pivoted-out position, of the plug socket, in which the plug is arranged at least partially outside the holder.

7. The bicycle or e-bike interface according to claim 6, wherein the bicycle or e-bike interface comprises return means, which create a pulling force between the plug socket and the holder, wherein the pulling force is greater in the first position than in the second position.

8. The bicycle or e-bike interface according to claim 7, wherein the plug socket is in a lock-in position in the second position, in which the pulling force of the return means is absorbed by a locking device.

9. The bicycle or e-bike interface according to claim 7, wherein the return means comprise a magnet and a magnetic counterpart.

10. The bicycle or e-bike interface according to claim 1, wherein the plug socket is configured to be connected to the holder and/or removed from the holder without tools.

11. The bicycle or e-bike interface according to claim 1, wherein the attachment means comprise at least one guide slot and a sliding block engaging in the guide slot and/or in that the attachment means comprise at least one protrusion, configured as a latching lug, which provides a stop with at least one counter protrusion.

12. The bicycle or e-bike interface according to claim 1, wherein the holder has fixing means for attaching the holder to the bicycle or e-bike and the fixing means comprise at least one retaining clip for engaging behind a region of the bicycle or e-bike and/or a screw, wherein the screw interacts with a fork nut of the holder, wherein the fork nut comprises a fork head with a female thread and fork prongs for support on the bicycle or e-bike, and wherein the fork nut is arranged on the holder in a captive manner by a catch strap of the holder and a holding claw of the holder.

13. The bicycle or e-bike interface according to claim 1, wherein the plug comprises a USB plug or is formed thereby.

14. The bicycle or e-bike interface according to claim 1, wherein the bicycle or e-bike interface has a display device, for example at least one LED and/or matrix display, such as an LCD display.

15. The bicycle or e-bike, comprising a bicycle or e-bike interface according to claim 1.

16. The bicycle or e-bike according to claim 15, wherein the bicycle or e-bike has an electric drive motor and a drive accumulator and the bicycle or e-bike interface is connected to the drive accumulator and/or to the drive motor by means of an electrical line.
